(19) United States
(12) Patent Application Publication
(10) Pub. No.: US 2020/0056943 A1
(43) Pub. Date: Feb. 20, 2020

(54) SYSTEMS AND METHODS FOR MATCHING SKIN TONE ACCESSORIES

(71) Applicant: Shades Of Shades, LLC, Charlotte, NC (US)

(72) Inventor: Marsha DOUGLAS-SYDNOR, Charlotte, NC (US)

(21) Appl. No.: 16/103,393

(22) Filed: Aug. 14, 2018

(51) Int. Cl. G01J 3/52; G01J 3/46

(52) U.S. Cl. CPC G01J 3/528; G06Q 30/0631; G01J 3/463

(57) ABSTRACT

Disclosed herein are systems and methods related to a line of fashion accessories available in various colors, spanning across the full gamut of human skin tone shades. Having a fashion accessory available in a range of skin tone shades may allow the fashion accessory to match and/or blend in with the wearer's skin complexion. Further disclosed are systems and methods of collecting data related to the particular makeup foundation a person wears and using the makeup foundation data to determine which skin tone shade the person should select for the fashion accessory.

### FIELD OF THE DISCLOSURE

The present disclosure relates generally to fashion accessories, such as glasses, sunglasses, jewelry, etc. More specifically, the present disclosure relates to systems and methods for matching an accessory to a skin tone of a wearer.

### BACKGROUND OF THE DISCLOSURE

A person's overall skin tone results from the amount of melanin pigment present in the skin cells of the epidermis in response to genetics and ultraviolet light exposure. Additionally, skin tones are affected by the presence of red hemoglobin and blue connective tissue. Besides color, skin complexion also varies in its characteristic reflectance. With all these factors, a person's skin tone can easily feel like a unique fingerprint, which may be used to express individuality.

Often in the fashion industry, designers will offer products in a nude shade. However, the nude shade offered will only match the skin tone of those within a narrow range of skin pigmentations. This lack of options can be especially disheartening for those with skin tones falling outside of the most common skin complexions.

U.S. Pat. No. 6,297,420 discloses methods for manufacturing bandages to match a person's skin tone, and U.S. Pat. No. 8,351,038 discloses methods for making prosthetics that match a patient's skin tone. However, these are medical applications individualized to patients in a more expensive healthcare environment, and do not reflect the same issues relevant in the mass production fashion industry.

Thus, there is a need for a line of fashion accessories offered in a variety of shades, spanning the full gamut of human skin tones, such that individuals may match the accessory to their own skin color.

### BRIEF SUMMARY OF THE DISCLOSURE

The present disclosure addresses the issues associated with matching fashion accessories with skin complexions. Providing fashion accessories that are available in a range of colors that spans across the possible skin tone shades for humans may allow for optimized matching and/or blending in with the wearer's skin complexion. A consumer may manually choose their complexion match from a set of skin tone shades or utilize a camera and/or photograph to automatically choose the closest match from the set of skin tone shades. Additionally, rather than having to automatically or manually select from the set of skin tone shades, the disclosed systems and methods allow the consumer to index their closest matching skin tone shade for the fashion accessory by using their makeup foundation information to cross-reference a database that correlates makeup foundations with one of the skin tone shades.

### BRIEF DESCRIPTION OF THE DRAWINGS

The present invention is illustrated and described herein with reference to the drawings, in which:

FIG. 1 is a diagram of a method for presenting a choice of fashion accessories in various skin tone shades, in accordance with the present disclosure;

FIG. 2 is a diagram of an example set of skin tone shades, in accordance with the present disclosure; and

FIG. 3 is a diagram of an example makeup foundation database indexed according to the set of skin tone shades, in accordance with the present disclosure.

### DETAILED DESCRIPTION OF THE DISCLOSURE

Providing fashion accessories in a variety of skin tone shades, spanning the full gamut of human skin pigmentations, may allow all wearers to express their individuality by proudly celebrating and augmenting their own skin. Conventionally, consumers looking to try to match a nude shade to their own skin tone would have to shop around at various stores and across different brands, since historically fashion brands have tended to only offer one or two nude or tan shades. Thus, if the consumer is even able to find shoes, for example, that match the consumer's skin tone, the shoes may not be in the consumer's desired style. This phenomenon can be especially disheartening for those with skin tones falling outside of the most common skin complexions. For example, the makeup industry has attempted to deal with these same issues arising with foundation shades. Providing a line of products available in skin tone shades across all complexion subgroups may allow all consumers to feel welcome and represented. Moreover, being able to select from a full gamut of skin tone shades may save the consumer time and frustration.

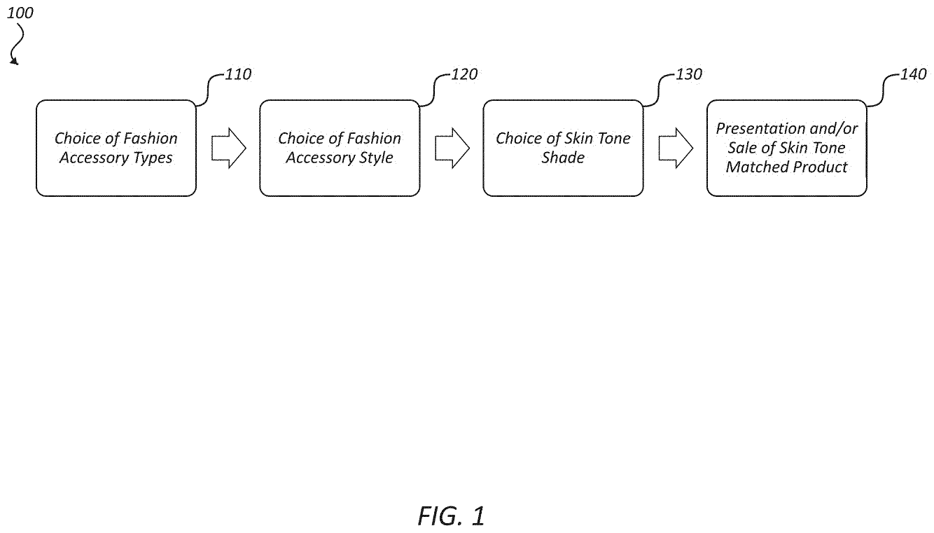

As shown in FIG. 1, within a method 100 of matching fashion accessories to skin tone, a consumer may be presented with a choice 110 of one or more types of fashion accessories, such as glasses, sunglasses, jewelry, and shoes, for example. After choosing a type of fashion accessory, the consumer may be presented with a choice 120 of various style options for the particular fashion accessory type. After choosing their desired style, the consumer may be presented with a choice 130 of color for the particular fashion accessory. Finally, as seen in step 140 of the method 100 in FIG. 1, the consumer may be presented with a representation of and/or a module for buying the particular fashion accessory product, based on selections that were made.

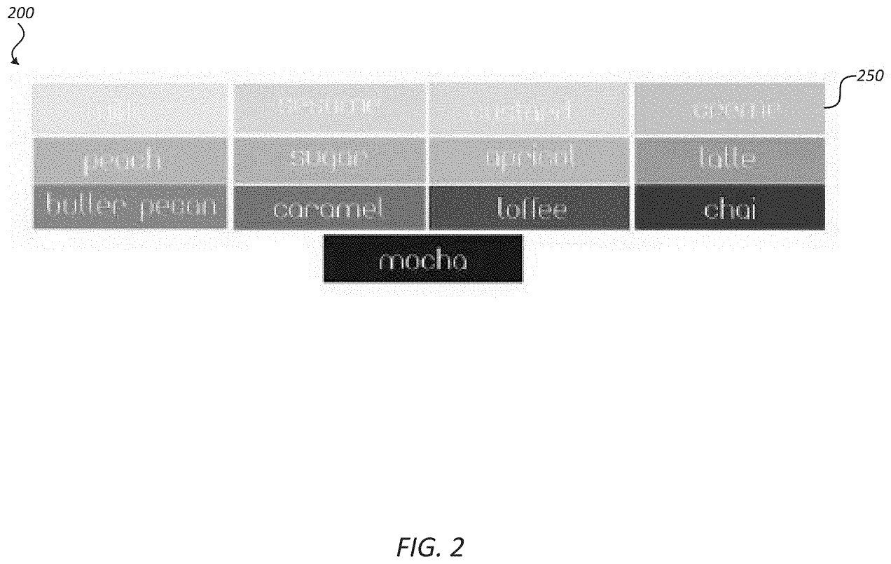

The choice of color presentation may include presenting a set of colors, correlating with various skin tone shades. The skin tone shades may range from Fair, Light, Medium, Light Brown, Olive to Dark Brown in color. The skin tone shades within the set of colors may be displayed along with unique names, numbers, and/or codes. The skin tone shades may be named according to a theme and/or according to their matching color characteristics. For example, as shown in FIG. 2, the set of colors 200 may include 13 skin tone shades 250 named Milk, Sesame, Custard, Crème, Peach, Sugar, Apricot, Latte, Butter Pecan, Caramel, Toffee, Chai, and Mocha. The skin tone shades within the set of colors may correlate to specific Hex Color Codes (e.g., # FEE4CD, # F0D5BA, # F9D6B8, # E9BD99, # E7AE84, # CC9769, # DEB381, # CB9463, # BF7F48, # AAED41, #825030, #693A20, #39261F). The set of colors may include anywhere from a few colors to hundreds of skin tone shades 250.

In some embodiments, the set of colors 200 may be organized or classified into subsets. The choice of color presentation may include the consumer being first presented with the subsets, into which the skin tone shades 250 within the set of colors 200 is distributed. For example, the subsets may correspond to the six skin types of the Fitzpatrick scale, outlining sun tanning responses (i.e., Types I, II, III, IV, V, and VI). Further, the set of colors may include 36 skin tone shades corresponding to the von Luschan scale, which may be subdivided into the six subsets of the Fitzpatrick scale, as is known.

The fashion accessories may be formed from plastic materials dyed to match the various skin tone shades. Alternatively, the fashion accessories may be formed from plastics, metals, composites, wood, and then painted to match the various skin tone shades. The fashion accessories may have a matte or satin finish, for example. Further, the fashion accessories may have specific reflectance and/or undertones to better match the skin complexion of the wearer. These material, finish, reflectance, and undertone options may be additionally presented as choices to the consumer.

In some embodiments, the fashion accessory is a pair of glasses or sunglasses. A frame color for a pair of glasses or sunglasses that matches the skin tone of the wearer may appear to blend in with the wearer's facial complexion. This effect may provide a pleasing aesthetic look and/or minimize the appearance of glasses on the wearer's face. A minimized appearance of glasses may be advantageous for those otherwise embarrassed by having to wear glasses. For example, a consumer may access an online retail site called shades-of-shades.com, where they can order COMPLEX™ brand sunglasses, frames, jewelry, and accessories in a shade matching their skin tone.

In some embodiments, the fashion accessory may be jewelry, such as earrings, necklaces, bracelets, rings, etc. Jewelry matching the skin tone of the wearer may provide an interesting and unique visual effect. For example, 3D printed structures within a necklace matching the skin tone of the user may give the appearance that the necklace is a continuation of the wearer's own skin. This opens up endless possibilities for designers in both the fashion and body enhancement industries.

The selection of the color from the set of skin tone shades may be performed in various ways. The consumer may manually select a skin tone shade 250 from the set of colors 200 in a skin tone shade chart, as shown in FIG. 2. As another example, the consumer may utilize a skin tone color selection tool as disclosed in U.S. Pat. No. 9,345,308 and/or U.S. Patent Publication No. 2006/0029909. Alternatively, the skin tone shade may be automatically selected from the set of colors 200. There are various ways to automatically select a skin tone shade from the set of colors 200 based on different input types of the consumer's skin tone shade. For example, the consumer may utilize a photosensor apparatus, as disclosed in U.S. Pat. Nos. 5,537,211, 9,064,279, and/or 9,519,927, where the photosensor apparatus is placed on or near the consumer's skin and measures the spectro-photometric data based on the light reflected back onto the photosensor from the consumer's skin. As another example, the consumer may upload a photo of their skin through an online or mobile app. The app may then analyze the skin pigmentation using a skin tone analysis module to determine which of the set of colors 200 most closely matches the pigmentation within the uploaded photo. The uploaded photo may include a light or white balance reference object placed near the consumer's skin to minimize color variation errors within the skin tone analysis module. This app or module may operate as outlined in U.S. Patent Publication Nos. 2007/0058858, 2013/0033590, and/or 2013/0300761.

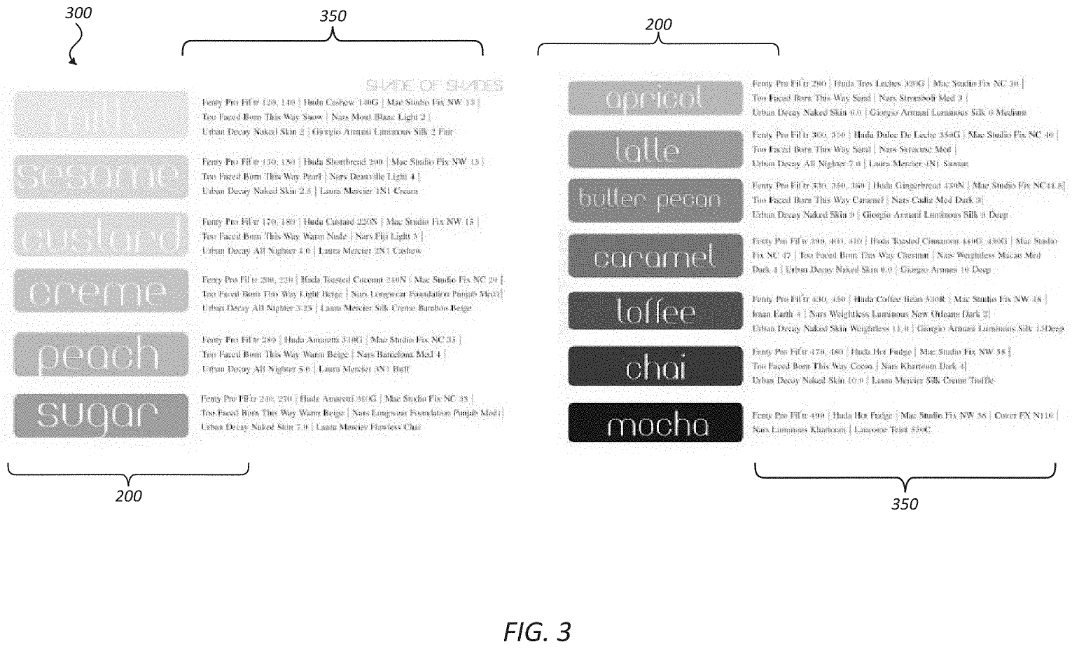

As shown in FIG. 3, some embodiments may include an index or database 300 of makeup foundations 350, each matched to a skin tone shade 250 within the set of colors 200. At times, it may be difficult to match colors in physical space to those in an online retail environment due to the color variations introduced by wide-ranging display hardware. Thus, utilizing a database 300 of makeup foundations 350 relieves the consumer of any uncertainty in the color matching, since the consumer is providing the specific details of a makeup foundation product that they already know matches their skin tone. Moreover, on the retailer's side, because they have already performed the matching of those makeup foundation products with the skin tone shades for the fashion accessories in creating the database, no further color matching is necessary, and the database may fully guide the consumer's shade selection without the introduction of color matching errors from guessing.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are contemplated thereby.

What is claimed is:

1. A system of fashion accessories comprising:
a presentation of fashion accessories in varying shades,
wherein the varying shades include at least four colors correlating to a range of skin tones.

2. The system of claim 1, wherein the fashion accessories are glasses.

3. The system of claim 1, wherein the fashion accessories are sunglasses.

4. The system of claim 1, wherein the fashion accessories are jewelry.

5. The system of claim 1, wherein the fashion accessories are shoes.

6. The system of claim 1, further comprising a database of makeup foundations, wherein each makeup foundation is matched to one color in the varying shades.

7. The system of claim 6, wherein the database of makeup foundations is indexed according to makeup brand and foundation color.

8. A method of matching fashion accessories to skin tone, the method comprising:
providing a choice of fashion accessory; and
presenting a choice of shade of the fashion accessory, wherein the choice of shade includes at least four colors, correlating to a range of skin tones from darker to lighter.

9. The method of claim 8, further comprising providing a choice of foundation, wherein each foundation is matched to a color within the choice of shade.

10. The method of claim 9, wherein the choice of foundation includes presenting both a choice of makeup brand and a choice of foundation color.

11. The method of claim 9, wherein choosing the foundation automatically chooses the shade of the fashion accessory.

12. The method of claim 8, wherein providing the choice of fashion accessory is within an online retail environment.

13. The method of claim 8, wherein the choice of fashion accessory includes presenting at least one of glasses, sunglasses, jewelry, and shoes.

14. The method of claim 8, further comprising providing a skin tone analysis module that utilizes a photo of a user to determine which of the colors within the choice of shade most closely matches the skin tone of the user.

15. A method of matching a fashion accessory with a skin tone of a user, the method comprising:
presenting a fashion accessory available in various colors, wherein the colors include a set of skin tone shades;
providing a database of makeup foundations, wherein each makeup foundation is associated with one skin tone shade within the set of skin tone shades;
querying the user for their makeup foundation details;
determining which skin tone shade is associated with the makeup foundation details by locating one makeup foundation in the database based on the makeup foundation details input by the user; and
selecting the determined skin tone shade for the color of the fashion accessory.

16. The method of claim 15, wherein querying the user for their makeup foundation details includes querying the user to select a makeup brand and a foundation color.

17. The method of claim 16, wherein querying the user to select a makeup brand and a foundation color includes presenting a dropdown menu.

18. The method of claim 15, wherein querying the user for their makeup foundation details includes providing the user with a text input box.

19. The method of claim 15, wherein querying the user for their makeup foundation details includes using an image of their makeup foundation to identify their makeup foundation details.

20. The method of claim 15, wherein the fashion accessory is at least one of glasses, sunglasses, jewelry, and shoes.
